(19) United States
(12) Patent Application Publication
(10) Pub. No.: US 2019/0169884 A1
(43) Pub. Date: Jun. 6, 2019

(54) Door Latch Apparatus for Motor Vehicles

(71) Applicants: Hyundai Motor Company, Seoul (KR); Kia Motors Corporation, Seoul (KR)

(72) Inventors: Min-Hyung Byun, Seoul (KR); Seok-Hyun Hong, Hwaseong-si (KR); Ki-Hwan Jeong, Seongnam-si (KR); Soon-Ho Her, Goyang-si (KR); Min-Wook Choi, Pyeongtaek-si (KR)

(21) Appl. No.: 16/186,972

(22) Filed: Nov. 12, 2018

(30) Foreign Application Priority Data
Dec. 4, 2017 (KR) 10-2017-0165303

(51) Int. Cl. E05B 77/30; E05B 79/20; E05B 79/22

(52) U.S. Cl. CPC E05B 77/30; E05Y 2900/531; E05B 79/22; E05B 79/20

(57) ABSTRACT

A door latch apparatus may include an inside handle lever to which operation force of an inside handle is transmitted via an inner knob cable, a lock lever for converting a door into a locked state or an unlocked state by means of operation of a safety knob, and a one-motion lever capable of rotating together with the inside handle lever when the inside handle lever is rotated.

### CROSS-REFERENCE TO RELATED APPLICATIONS

This application claims priority to Korean Patent Application No. 10-2017-0165303, filed on Dec. 4, 2017, which application is hereby incorporated herein by reference.

### TECHNICAL FIELD

Exemplary embodiments of the present invention relate to a door latch apparatus for opening and closing a door of a motor vehicle.

### BACKGROUND

A door locking mechanism of a vehicle is equipped with a door latch apparatus and has a safety lock function for locking the door latch apparatus such that release of the door latch apparatus is prohibited.

Therefore, when the door latch apparatus is locked by means of the safety knob provided in the interior of the vehicle or the door latch apparatus is locked by means of a key outside the door, locked state of the door latch apparatus cannot be released basically even when operating an inside handle in the interior of the vehicle or operating an outside handle outside the door and thus the door cannot be opened.

However, when a user intends to open the door in the interior, the user must release first the safety knob and then operate the inside handle to release the locked state of the door latch apparatus and open the door. As such, there has been inconvenience due to double operation of the user. In order to solve this problem, there was an attempt to provide an override function for allowing the locked state of the door latch apparatus to be released by simply operating the inside handle and thus allowing the door to be opened.

The conventional door latch apparatus having such an override function as shown in FIG. 1 includes an inside handle lever 1 for transmitting operation force of an inside handle and a lock lever 2 for operating a door to be set into a locked state or an unlocked state.

Therefore, when the inside handle is operated, the inside handle lever 1 is pulled and thus a pole lever (not shown) is rotated so that the locked state of the door is released by rotation of the pole lever and in turn the door is opened.

Further, when the safety knob is operated, the safety lever (not shown) forces the lock lever 2 to rotate and in turn the locked state is switched to the unlocked state by the lock lever 2.

In other words, when the inside handle lever 1 is rotated clockwise from the locked state as shown in the left view of FIG. 2 by operation of the inside handle, the lock lever 2 is rotated counterclockwise in conjunction with such rotation of the inside handle lever and in turn the locked state of the door is released and in turn the door is opened.

However, when the inside handle lever is forcibly rotated under an unfavorable condition where the safety knob is constrained and locked, impact between the inside handle lever and the lock lever 2 is caused as shown in FIG. 3 and load of the lever cannot be dispersed, resulting in breakdown of the lever or damage of a cable broken away.

In order to solve this problem, there was an attempt to increase engagement amount with a master lock link of the inside handle lever to increase operation force. However, this could not be a fundamental countermeasure, rather there occurred a phenomenon that the inside handle lever 1 goes over the master lock link 2 as shown in FIG. 4.

The foregoing described in the section of the background of the invention is intended to assist understanding of the background of the invention and may include matters not previously known to those having ordinary skill in the field of the art.

Korean Laid-Open Patent Publication No. 10-2009-0064225 is related to subject matter discussed herein.

### SUMMARY

Embodiments of the present invention can solve problems associated with the prior art. Embodiments of the present invention provide a door latch apparatus capable of preventing breakdown of an inside handle lever due to impact that will occur at the time of rotating the inside handle lever under an unfavorable condition where a safety knob is constrained and locked.

Other advantages of the present invention can be understood by the following description, and become apparent with reference to the embodiments of the present invention. Also, it is obvious to those skilled in the art to which the present invention pertains that the advantages of the present invention can be realized by the means as claimed and combinations thereof.

In accordance with one aspect of the present invention, a door latch apparatus comprises an inside handle lever to which operation force of an inside handle is transmitted via an inner knob cable. A lock lever is used for converting a door into a locked state or an unlocked state by means of operation of a safety knob. A one-motion lever is capable of rotating together with the inside handle lever when the inside handle lever is rotated.

A pivot shaft of the lock lever is shared with the one-motion lever and a motion spring is coupled between the lock lever and the one-motion lever so that when the one-motion lever is rotated, the lock lever is also rotated together with the one-motion lever as far as any external force that may elastically deform the motion spring is not exerted thereto.

Further, the inside handle lever is not in direct contact with the lock lever when it is rotated.

Therefore, the inside handle lever pushes and forces the one-motion lever to rotate when it is rotated.

More specifically, the inside handle lever is formed with a push end protruding toward the one-motion lever so that the push end pushes and forces the one-motion lever to rotate when the inside handle lever is rotated.

On the other hand, the push end of the inside handle lever is configured to be spaced apart from a push face corresponding to one end of the one-motion lever when the door is locked, wherein the push end depresses first the push face when the inside handle lever is rotated and then moves along a lower surface of the one-motion lever.

Further, when the inside handle lever is rotated while the lock lever is constrained, the motion spring is deformed elastically and the one-motion lever is rotated accordingly.

According to the door latch apparatus of the present invention, even if the safety knob is constrained and locked, the one-motion lever can be rotated when the inside handle lever is rotated, so that risk of breakdown or buckling of the inside handle lever as occurred in the prior art can be avoided.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a conventional door latch apparatus;

FIGS. 2 and 3 show operation of the door latch apparatus of FIG. 1;

FIG. 4 illustrates a problem in the door latch apparatus of FIG. 1;

FIG. 5a shows a door latch apparatus according to an embodiment of the present invention and FIG. 5b shows a part of FIG. 5a in a plan view; and

FIGS. 6a and 7a show operation of a door latch apparatus according to an embodiment of the present invention and FIGS. 6b and 7b show a part of FIGS. 6a and 7a in a plan view respectively.

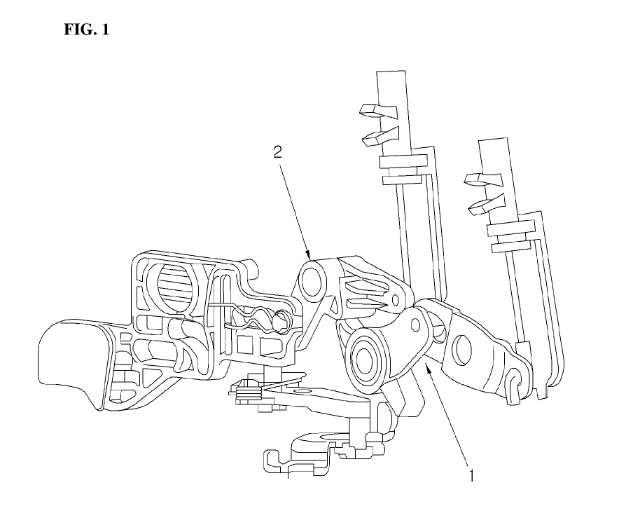

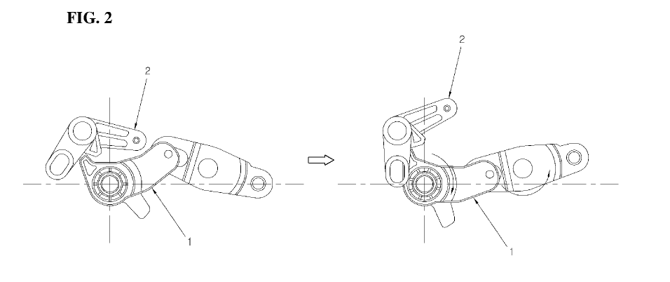

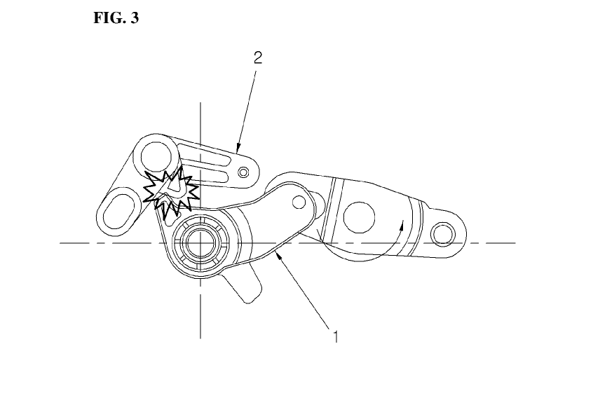

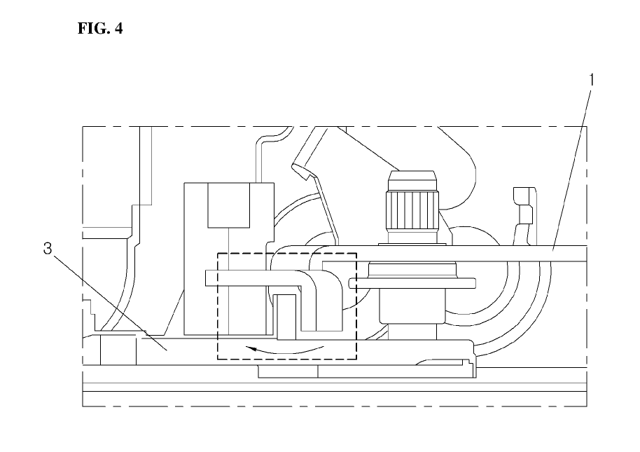

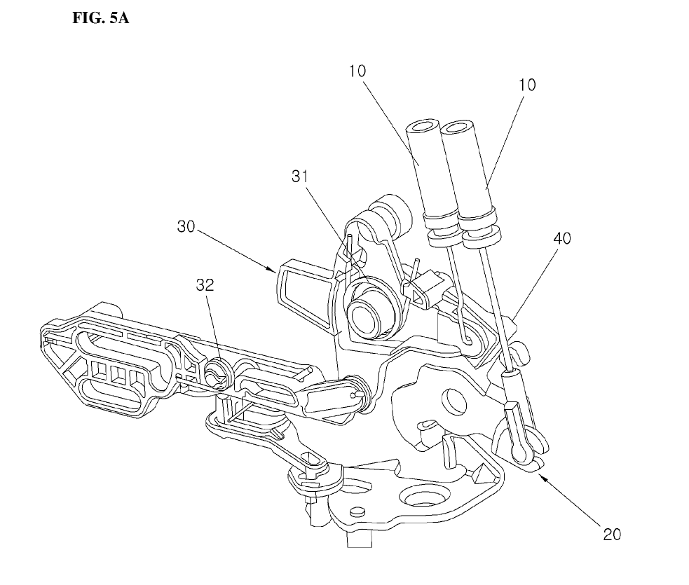

### DETAILED DESCRIPTION OF ILLUSTRATIVE EMBODIMENTS

In order to fully understand the present invention, operational advantages of the present invention and objects accomplished by practicing the present invention, reference should be made to the accompanying drawings illustrating preferred embodiments of the present invention and illustrations in the accompanying drawings.

In describing below the preferred embodiments of the present invention, description about the prior art or repetitive description that may unnecessarily obscure essential features of the present invention will be reduced or omitted.

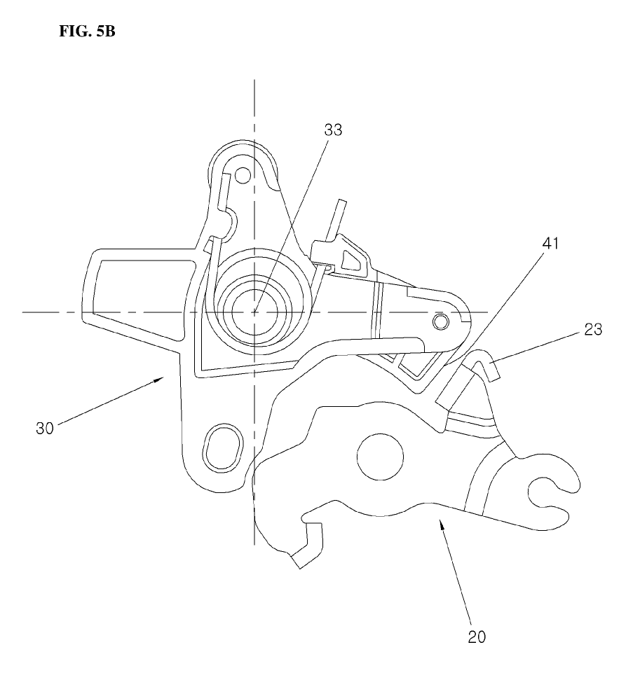

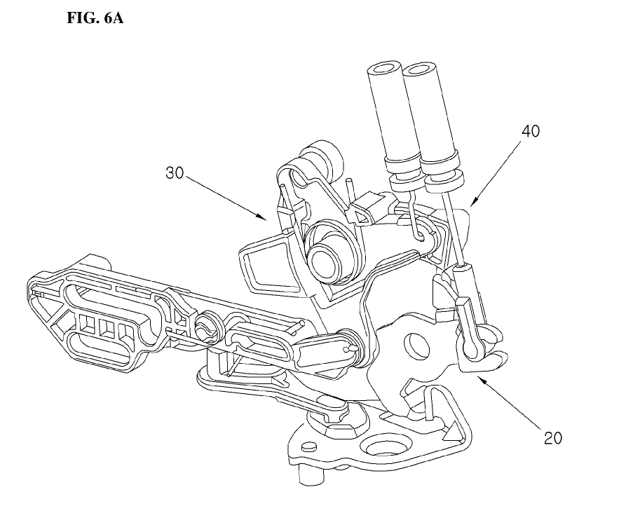

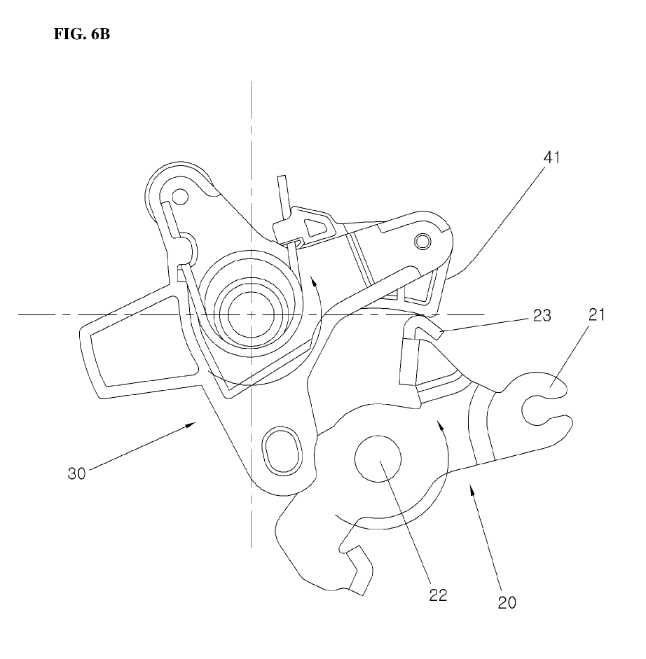

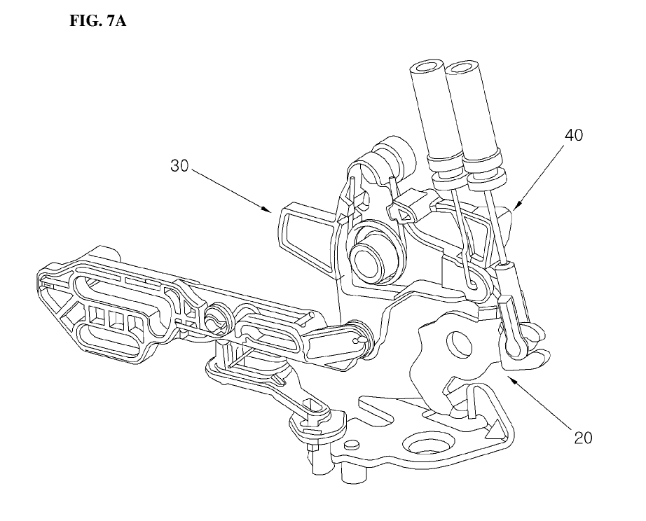

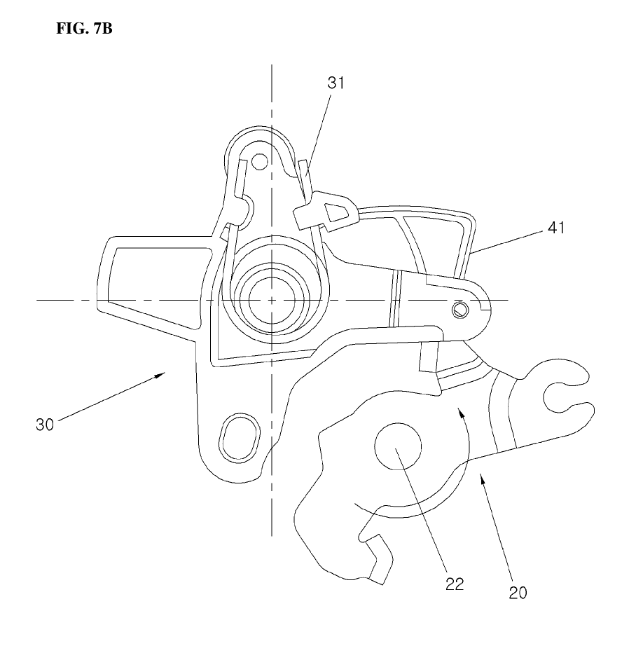

FIG. 5a shows a door latch apparatus according to an embodiment of the present invention, FIG. 5b shows a part of FIG. 5a in a plan view, FIGS. 6a and 7a show operation of a door latch apparatus according to an embodiment of the present invention, and FIGS. 6b and 7b show a part of FIGS. 6a and 7a in a plan view respectively.

A door latch apparatus according to an embodiment of the present invention will now be described with reference to these drawings.

A door latch apparatus according to an embodiment of the present invention comprises an inside handle lever 20 to which operation force of the inside handle lever is transmitted by an inner knob cable 10 and a lock lever 30 allowing a door to be set into a locked state or an unlocked state by being rotated according to rotation of the inside handle lever 20.

Further, it comprises a one-motion lever 40 configured to be rotated when the inside handle lever 20 is rotated even under an unfavorable condition that a safety knob is constrained and locked, so that no problem such as breakdown occurs even if the inside handle lever 20 is forcibly rotated.

The inside handle lever 20 has an annular cable coupling end 21 formed at its one end so that it is coupled to the inner knob cable 10 through the cable coupling end 21. As a result, the inside handle lever is capable of rotating counterclockwise in the drawing with respect to a pivot shaft 22 of the handle lever when the inner knob cable 10 is pulled.

The lock lever 30 is rotated counterclockwise with respect to a pivot shaft 33 of the lock lever when the inside handle lever 20 is rotated, resulting in unlock of the door.

However, according to the present invention, the inside handle lever 20 is not in contact with the lock lever 30 and does not directly rotate the lock lever but rotates the lock lever via the one-motion lever 40.

This one-motion lever 40 is coupled to the pivot shaft 33 of the lock lever 30 by using the pivot shaft as a common shaft and rotates counterclockwise as shown in FIG. 6 when the inside handle lever 20 is rotated.

The lock lever 30 and the one-motion lever 40 are configured such that both ends of a motion spring 31 are coupled thereto respectively, so that in a normal state as shown in FIG. 6, the lock lever 30 is also rotated when the one-motion lever 40 is rotated by spring force of the motion spring 31.

For this operation, the inside handle lever 20 is formed with a push end 23 having a shape protruding toward the one-motion lever 40.

In addition, the one-motion lever 40 has a configuration extending from the pivot shaft 33 of the lock lever 30 to the inside handle lever 20 side wherein one side thereof facing the push end 23 of the inside handle lever 20 becomes a push face 41 that will contact first with the push end 23 when the inside handle lever 20 rotates.

Accordingly, when the inside handle lever 20 is rotated counterclockwise in a state where the push end 23 and the push face 41 are spaced apart from each other as shown in FIG. 5, the push end 23 depresses the push face 41 of the one-motion lever 40 as shown in FIG. 6 in a normal state. In this case, the one-motion lever 40 rotates counterclockwise with respect to the pivot shaft 33 of the lock lever so that the push end 23 moves along the lower surface of the one-motion lever 40.

At this time, as the one-motion lever 40 rotates, the lock lever 30 coupled to the motion spring 31 also rotates together with the one-motion lever so that the locked state of the door is released by the lock lever 30 and thus override function is implemented.

However, under an unfavorable condition where the safety knob is constrained and locked, the lock lever 30 is not rotated but the motion spring 31 is elastically deformed and thus the one-motion lever 40 is rotated as shown in FIG. 7.

As such, it is possible to prevent breakdown or buckling of the inside handle lever due to any interference with the lock lever 30 which does not rotate when the inside handle lever 20 is forcibly rotated.

On the other hand, when the lock lever 30 is forced to rotate counterclockwise by operation of the safety knob rather than override function, the inside handle lever 20 is completely separated from the one-motion lever 40. In order for this state to be established, an action spring 32 coupled between a base plate and the lock lever 30 is in a state of pushing the lock lever 30.

Further, under the locked state as shown in FIG. 5, the one-motion lever 40 is not constrained and rotated as far as the inside handle lever 20 is not operated. In this case, the action spring 32 is in a state of pulling the lock lever 30.

Although the present invention has been described in the foregoing with reference to the drawings illustrated by way of example, the present invention is not limited to the disclosed embodiments, and it will be apparent to those of ordinary skill in the art that various modifications and variations can be made to the present invention without departing from the spirit and scope of the invention. Therefore, such modifications or variations fall within the scope of the present invention as claimed and the scope of the present invention should be interpreted based on the appended claims.

What is claimed is:

1. A door latch apparatus comprising:
an inside handle lever to which operation force of an inside handle is transmitted via an inner knob cable;
a lock lever designed to convert a door into a locked state or an unlocked state by operation of a safety knob; and
a one-motion lever capable of rotating together with the inside handle lever when the inside handle lever is rotated.

2. The door latch apparatus according to claim 1, wherein a pivot shaft of the lock lever is shared with the one-motion lever and a motion spring is coupled between the lock lever and the one-motion lever so that when the one-motion lever is rotated, the lock lever is also rotated together with the one-motion lever as far as any external force that may elastically deform the motion spring is not exerted thereto.

3. The door latch apparatus according to claim 2, wherein the inside handle lever is not in direct contact with the lock lever when inside handle lever is rotated.

4. The door latch apparatus according to claim 3, wherein the inside handle lever pushes and forces the one-motion lever to rotate when it is rotated.

5. The door latch apparatus according to claim 4, wherein the inside handle lever is formed with a push end protruding toward the one-motion lever so that the push end can push and force the one-motion lever to rotate when the inside handle lever is rotated.

6. The door latch apparatus according to claim 5, wherein the push end of the inside handle lever is configured to be spaced apart from a push face corresponding to one end of the one-motion lever when the door is locked, and wherein the push end is configured to first depress the push face when the inside handle lever is rotated and then move along a lower surface of the one-motion lever.

7. The door latch apparatus according to claim 2, wherein when the inside handle lever is rotated while the lock lever is constrained, the motion spring is deformed elastically and the one-motion lever is rotated accordingly.

8. A vehicle comprising:
a vehicle door that can be switched between a locked state and an unlocked state;
an inner knob cable;
an inside handle lever to which operation force of an inside handle is transmitted via the inner knob cable;
a safety knob;
a lock lever designed to convert the vehicle door into the locked state or the unlocked state by operation of the safety knob; and
a one-motion lever capable of rotating together with the inside handle lever when the inside handle lever is rotated.

9. The vehicle according to claim 8, wherein a pivot shaft of the lock lever is shared with the one-motion lever and wherein the vehicle further comprises a motion spring coupled between the lock lever and the one-motion lever so that when the one-motion lever is rotated, the lock lever is also rotated together with the one-motion lever as far as any external force that may elastically deform the motion spring is not exerted thereto.

10. The vehicle according to claim 9, wherein the inside handle lever is not in direct contact with the lock lever when the inside handle lever is rotated.

11. The vehicle according to claim 10, wherein the inside handle lever pushes and forces the one-motion lever to rotate when it is rotated.

12. The vehicle according to claim 11, wherein the inside handle lever is formed with a push end protruding toward the one-motion lever so that the push end can push and force the one-motion lever to rotate when the inside handle lever is rotated.

13. The vehicle according to claim 12, wherein the push end of the inside handle lever is configured to be spaced apart from a push face corresponding to one end of the one-motion lever when the door is locked, and wherein the push end is configured to first depress the push face when the inside handle lever is rotated and then move along a lower surface of the one-motion lever.

14. The vehicle according to claim 9, wherein the motion spring is deformed elastically and the one-motion lever is rotated accordingly when the inside handle lever is rotated while the lock lever is constrained.
